(19) United States
(12) Patent Application Publication
(10) Pub. No.: US 2014/0368478 A1
(43) Pub. Date: Dec. 18, 2014

(54) ELECTRONIC APPARATUS AND ASSOCIATED FRAME UPDATING METHOD

(71) Applicant: Quanta Computer Inc., Tao Yuan Shien (TW)

(72) Inventors: Tai-Hsin CHU, Taipei City (TW); Wei-Ting LU, Tainan City (TW); Tsung-Lin CHAN, Taichung City (TW); Hsin-Wei CHEN, Taoyuan County (TW); Zih-Chiang WANG, Taoyuan County (TW)

(73) Assignee: QUANTA COMPUTER INC., Tao Yuan Shien (TW)

(21) Appl. No.: 14/065,827

(22) Filed: Oct. 29, 2013

(30) Foreign Application Priority Data
Jun. 17, 2013 (TW) 102121330

(51) Int. Cl. G09G 5/00

(52) U.S. Cl. CPC G09G 5/003
USPC 345/204

(57) ABSTRACT

An electronic apparatus including a display block and a system block is provided. The display block includes a display panel for displaying a frame. The system block includes a comparison unit, an information generation unit and a transmission circuit. The comparison unit compares first frame data with second frame data to generate partial frame data. The information generation unit generates start information and address information according to the partial frame data. The transmission circuit transmits the start information, the address information and the partial frame data to the display block. The display block updates a part of the frame according to the start information, the address information and the partial frame data.

This application claims the benefit of Taiwan application Serial No. 102121330, filed Jun. 17, 2013, the subject matter of which is incorporated herein by reference.

### BACKGROUND OF THE INVENTION

1. Field of the Invention

The invention relates to an electronic apparatus and associated frame updating method.

2. Description of the Related Art

FIG. 1 shows a timing diagram of a vertical synchronization signal, a horizontal synchronization signal and a data signal in a conventional electronic apparatus. FIG. 2 shows a schematic diagram of a conventional electronic apparatus. Referring to FIGS. 1 and 2, an electronic apparatus 2 comprises a display block 21, a system block 22, a vertical synchronization signal line 23, a horizontal synchronization signal line 24 and a data bus 25. The vertical synchronization signal line 23 transmits a vertical synchronization signal Vsync1, and the horizontal synchronization signal line 24 transmits a horizontal synchronization signal Hsync1. The data bus 25 transmits a data signal Data1, which contains frame data of an entire frame.

When the display block 21 has a resolution of 1360×768, it means that the display block 21 has 768 display lines, each of which includes 1360 pixels. The 1360 pixel respectively correspond to pixel data D(1) to D(1360). The horizontal synchronization signal Hsync1 includes horizontal pulses H(1) to H(768). Upon receiving the vertical synchronization signal Vsync1, the display block 21 sequentially updates the display lines according to the horizontal synchronization signal Hsync1 and the pixel data D(1) to D(1360) until all of the display lines are updated. For example, upon receiving the vertical synchronization signal Vsync1, the display block 21 updates the 1^{st} display line according to the horizontal pulse H(1) of the horizontal synchronization signal Hsync1 and the pixel data D(1) to D(1360), and then updates the 2^{nd} display line according to the horizontal pulse H(2) of the horizontal synchronization signal Hsync1 and the pixel data D(1) to D(1360). Similarly, according to the horizontal pulses H(3) to H(768) of the horizontal synchronization signal Hsync1 and the corresponding pixel data D(1) to D(1360), the 3^{rd} to the 768^{th} display lines are updated. In most situations, the frame only needs to be partially updated. However, the system block 22 of the conventional electronic apparatus 2 nevertheless transmits the frame data of the entire frame to the display block 21, leading to unnecessary power consumption of the system block 21 and the display block 22.

### SUMMARY OF THE INVENTION

The invention is directed to an electronic apparatus and associated frame updating method, in which a system block transmits only a part of frame data to a display block instead of frame data of an entire frame. Therefore, power consumption of the electronic apparatus is effectively reduced.

An electronic apparatus is provided according to an embodiment of the present invention. The electronic apparatus comprises a system block and a display block. The display block comprises a display panel for displaying a frame. The system block comprises a comparison unit, an information generation unit and a transmission circuit. The comparison unit compares first frame data with second frame data to generate partial frame data. The information generation unit generates start information and address information according to the partial frame data. The transmission circuit transmits the start information, the address information and the partial frame data to the display block. The display block updates a part of the frame according to the start information, the address information and the partial frame data.

A frame updating method is further provided according to another embodiment of the present invention. The frame updating method comprises: displaying a frame; comparing first frame data with second frame data to generate partial frame data; generating start information and address information according to the partial frame data; transmitting the start information, the address information and the partial frame data by a system block to a display block; and updating a part of the frame according to the start information, the address information and the partial frame data by the display block.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 shows a timing diagram of a vertical synchronization signal, a horizontal synchronization signal and a data signal in a conventional electronic apparatus.

FIG. 2 shows a schematic diagram of a conventional electronic apparatus.

FIG. 3 shows a schematic diagram of an electronic apparatus according to a first embodiment.

FIG. 4 shows a flowchart of a frame updating method according to the first embodiment.

FIG. 5 shows a schematic diagram of a system block.

FIG. 6 shows a timing diagram of a vertical synchronization signal, a horizontal synchronization signal and a data signal according to the first embodiment.

FIG. 7 shows a partial timing diagram of a horizontal synchronization signal and partial frame data according to the first embodiment.

FIG. 8 shows a partial timing diagram of a vertical synchronization signal, a horizontal synchronization signal and a data signal according to a second embodiment.

FIG. 9 shows a partial timing diagram of a vertical synchronization signal, a horizontal synchronization signal and a data signal according to a third embodiment.

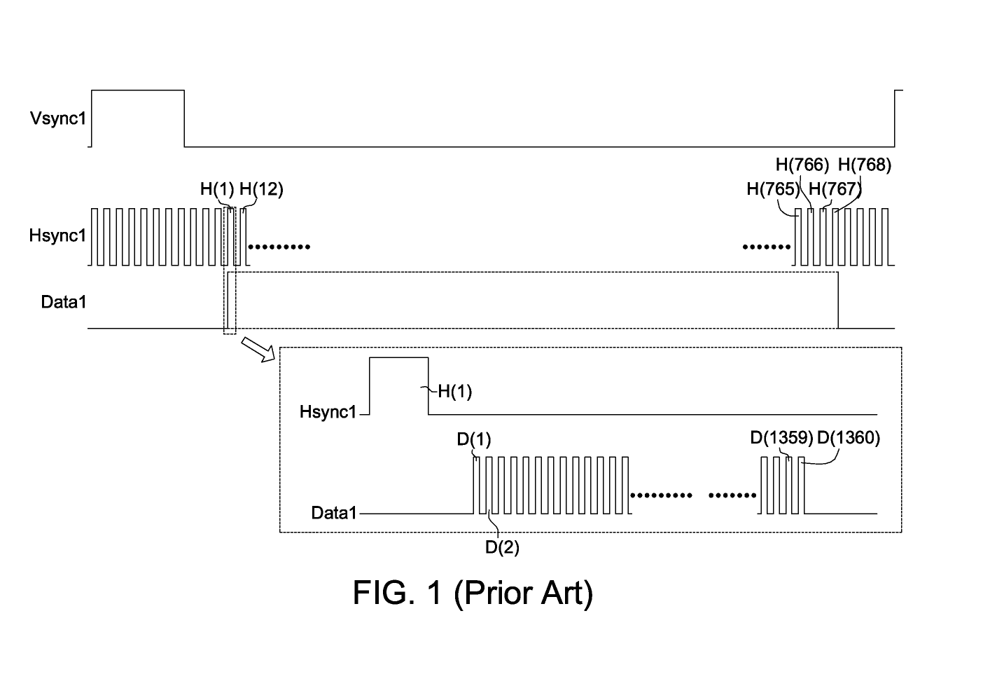

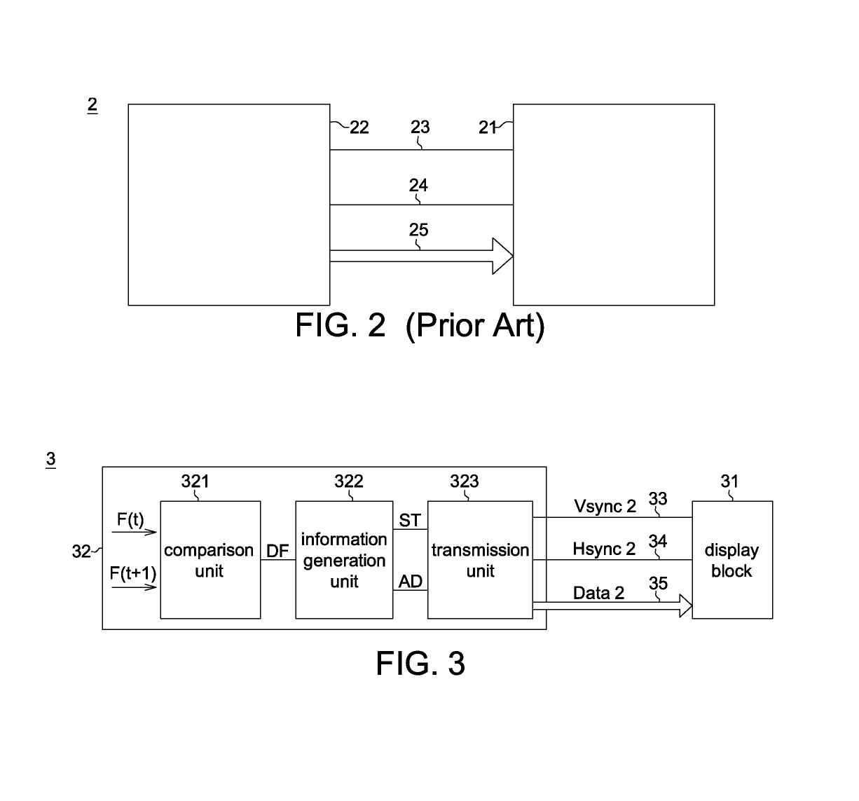

### DETAILED DESCRIPTION OF THE INVENTION

### First Embodiment

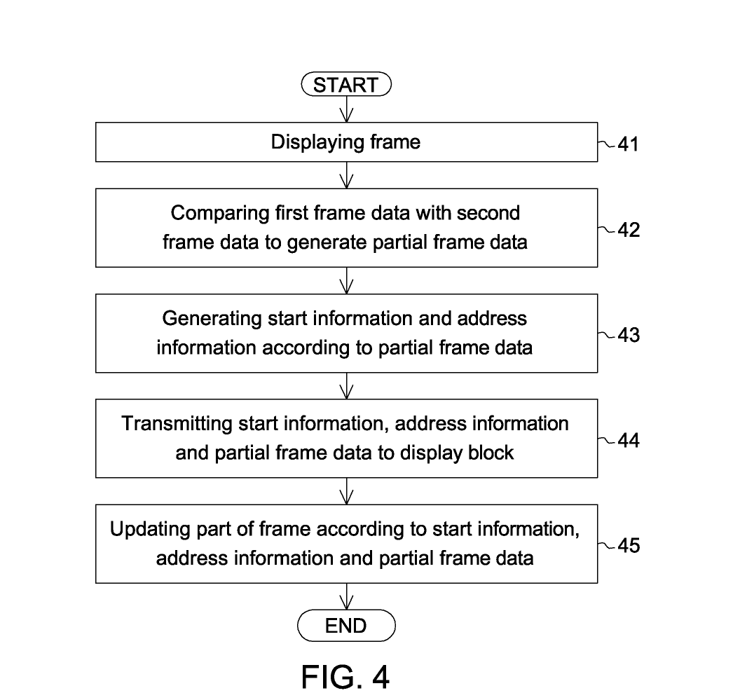

FIG. 3 shows a schematic diagram of an electronic apparatus according to a first embodiment; FIG. 4 shows a flowchart of a frame updating method according to the first embodiment. Referring to FIGS. 3 and 4, an electronic apparatus 3 comprises a display block 31, a system block 32, a vertical synchronization signal line 33, a horizontal synchronization signal line 34 and a data bus 35. The vertical synchronization signal line 33, the horizontal synchronization signal line 34 and the data bus 35 are for connecting the display block 31 to the system block 32. The vertical synchronization signal line 33 transmits a vertical synchronization signal Vsync2, which comprises start information ST and address information AD. The horizontal synchronization signal line 34 transmits a horizontal synchronization signal Hsync2. The data bus 35 transmits a data signal Data2, which comprises partial frame data DF. For example, the display block 31 is a display module for displaying a frame. For example, a data transmission format of the data bus 35 is LVDS, RSDS, eDP, TMSD, HDMI or DisplayPort, each of which may include a vertical synchronization signal, a horizontal synchronization signal and a data signal. The system block 32 comprises a comparison unit 321, an information generation unit 322 and a transmission circuit 323. For example, the comparison unit 321 and the information generation unit 322 are implemented by a processor.

The frame updating method according to the first embodiment comprises the following steps. In step S41, the display block 31 displays a frame. In step 42, the comparison unit 321 compares first frame data F(t) with second frame data F(t+1) to generate the partial frame data DF. In step 43, the information generation unit 322 generates the start information ST and the address information AD according to the partial frame data DF. In step 44, the transmission circuit 323 transmits the start information ST, the address information AD and the partial frame data DF to the display block 31. In the first embodiment, the start information ST and the address information AD are transmitted by the vertical synchronization signal line 33, and the partial frame data DF of the data signal Data2 is transmitted by the data bus 35. In step 45, the display block 31 updates a part of the frame according to the start information ST, the address information AD and the partial frame data DF.

In most cases, only a part of a frame needs to be updated when updating the frame. Hence, the display block 31 replaces an entirely updated frame by the partly updated frame. As such, since a remaining part of the frame need not be updated, the data bus 35 is not required to transmit frame data corresponding to the remaining part of the frame. When not transmitting frame data to the display block 31, the system block 32 enters a power-saving mode. For example, when the system block 32 is in a power-saving mode, an operating frequency or an operating voltage is reduced to reduce power consumption.

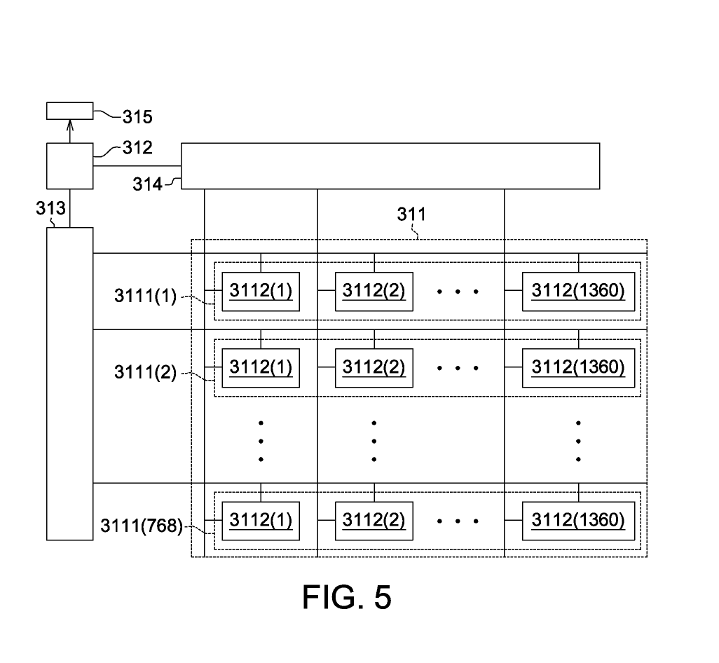

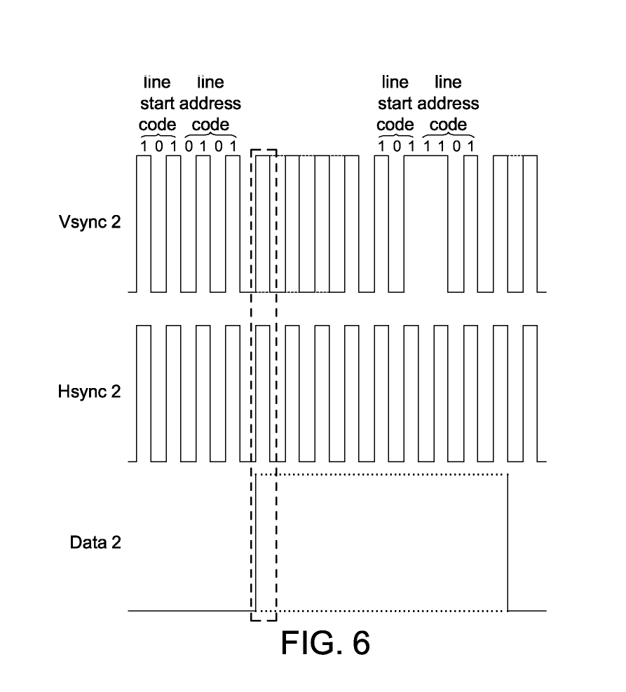

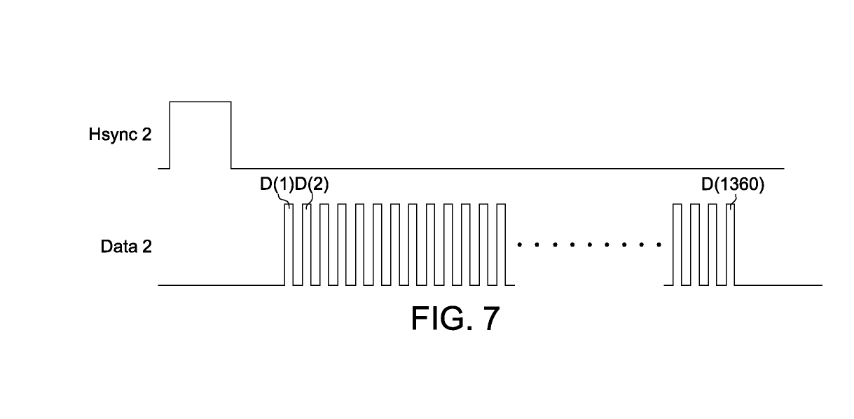

FIG. 5 shows a schematic diagram of a display block; FIG. 6 shows a timing diagram of a vertical synchronization signal, a horizontal synchronization signal and partial frame data according to the first embodiment; FIG. 7 shows a partial timing diagram of a horizontal synchronization signal and partial frame data according to the first embodiment. Referring to FIGS. 3, 5, 6 and 7, the display block 31 comprises a display panel 311, a timing controller 312, a scan driver 313, a data driver 314 and a backlight module 315. The timing controller 312 controls the timing controller 312 and the scan driver 313 to update a part of a frame according to the start information ST, the address information AD and the partial frame data DF. The display panel 311 comprises a plurality of display lines, each of which comprises a plurality of pixels. For example, the display panel 311 has a resolution of 1360×768, and comprises display lines 3111(1) to 3111(768) each comprising pixels 3112(1) to 3112(1360).

The start information ST comprises a line start code, and the address information AD comprises a line address code. The partial frame data DF of the data signal Data2 comprises pixel data D(1) to D(1360) respectively corresponding to the pixels 3112(1) to 3112(1360). The display block 31 updates the pixels 3112(1) to 3112(1360) according to the line start code, the line address code and the pixel data D(1) to D(1360). When the line address code is 4-bit, the display lines 3111(1) to 3111(768) may be divided into 16 horizontal blocks each comprising 48 scan lines. Further, upon receiving a line start code 101, the display block 31 learns according to a line address code 0101 that the 6^{th} horizontal block needs to be updated. The 6^{th} horizontal block comprises the display lines 3111(241) to 3111(288), and so the display block 31 starts updating from the 241^{st} display line 3111(241). It should be noted that, instead of transmitting all pixel data of the display lines 3111(241) to 3111(288), the system block 32 is required to transmit only updated pixel data of the display lines 3111(241) to 3111(288).

Similarly, upon later receiving the line start code 101, the display block 31 learns according to a line address code 1101 that the 14^{th} horizontal block needs to be updated. The 14^{th} horizontal block comprises the display lines 3111(625) to 3111(672), and so the display block 31 starts updating from the 625^{th} display line 3111(625). Further, instead of transmitting all pixel data of the display lines 3111(625) to 3111(672), the system block 32 is required to transmit only updated pixel data of the display lines 3111(625) to 3111(672).

The timing controller 312 may further control a size of a backlight region of the backlight module 315 according to the address information AD. When the display panel 311 is required to display a part of a frame, the timing controller 312 correspondingly illuminates only a part of light-emitting components of the backlight module 315 according to the address information AD to further enhance the power-saving effect. Similarly, when the display panel 311 is required to display a part of a frame, the timing controller 312 correspondingly activates only a part of driving circuits according to the address information AD and deactivates other unnecessary driving circuits to further enhance the power-saving effect.

### Second Embodiment

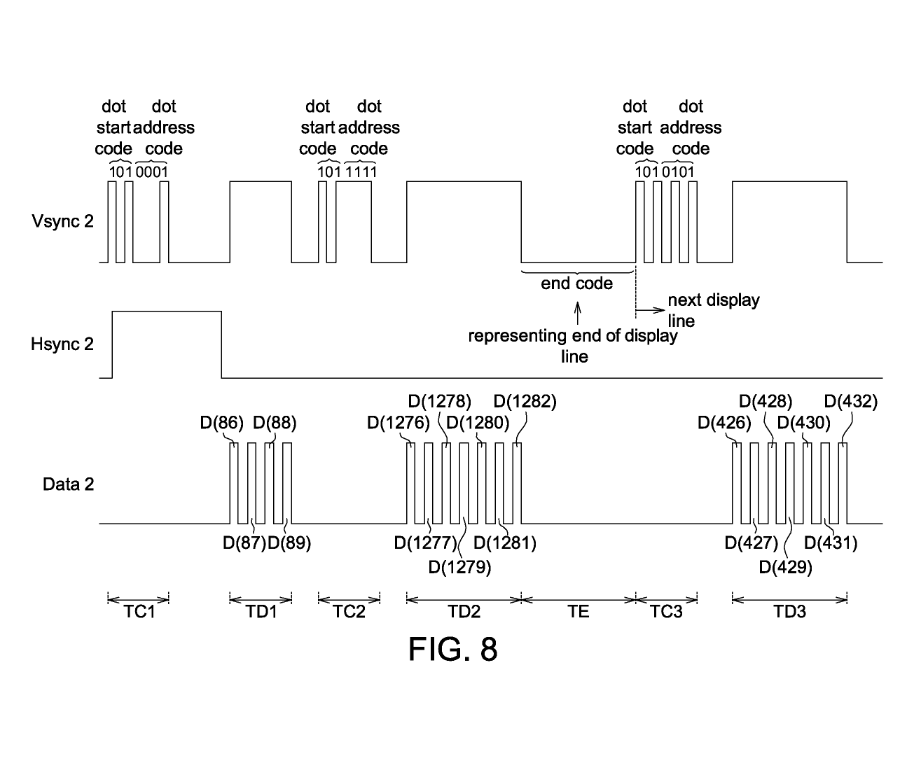

FIG. 8 shows a partial timing diagram of a vertical synchronization signal, a horizontal synchronization signal and partial frame data according to a second embodiment. Referring to FIGS. 3, 5, 6 and 8, a main difference of the second embodiment from the first embodiment is that, the start information ST in the second embodiment comprises a line start code and a dot start code, and the address information AD comprises a line address code and a dot address code. In the second embodiment, in addition to the line start code and the line address code (as shown in FIG. 6), the vertical synchronization signal Vsync2 further comprises a dot start code, a dot address code and an end code. The data signal DATA2 in the second embodiment comprises the partial frame data DF. The partial frame data DF comprises the pixel data D(86) to D(89), the pixel data D(1276) to D(1282) and the pixel data D(426) to D(432) of the next display line. The pixel data D(86) to D(89), pixel data D(1276) to D(1282) and pixel data D(426) to D(432) of the next display line respectively correspond to the pixels 3112(86) to 3112(89), the pixels 3112(1276) to 3112(1282) and the pixels 3112(426) to 3112(432). The display block 31 updates the pixels 3112(86) to 3112(89), the pixels 3112(1276) to 3112(1282) and the pixels 3112(426) to 3112(432) according to the line start code, the line address code, the dot start code, the dot address code, the pixel data D(86) to D(89), the pixel data D(1276) to D(1282) and the pixel data D(426) to D(432) of the next display line.

The vertical synchronization signal line 33 transmits a corresponding dot start and a corresponding dot address code in command transmission periods TC1 to TC3, respectively. The data bus 35 transmits the pixel data D(86) to D(89), the pixel data D(1276) to D(1282) and the pixel data D(426) to D(432) in data transmission periods TD1 to TD3, respectively. In the data transmission period TD1, the data transmission period TD2 and the data transmission period TD3, the vertical synchronization signal Vsync2 maintains at an enable level.

Similarly, when the line address code is 0101, it means that the display block 31 starts updating from the 241^{st} display line 3111(241), with however the pixels 3112(1) to 3112(1360) of the display line 3111(241) only partially updated. When the dot address code is 4-bit, the pixels 3112(1) to 3112(1360) may be divided into 16 vertical blocks each comprising 85 pixels. Further, upon receiving the dot start code 101, the display block 31 learns according to a dot address code 0001 that the 2^{nd} vertical block needs to be updated. The 2^{nd} vertical block comprises the pixels 3112(86) to 3112(170), and so the display block 31 starts updating from the 86^{th} pixel 3112(86), and updates the pixels 3112(86) to 3112(89) according to the pixel data D(86) to D(89). Upon later receiving the dot start code 101, the display block 31 learns according to a dot address code 1111 that the 16^{th} vertical block needs to be updated. The 16^{th} vertical block comprises the pixels 3112(1276) to 3112(1282), and so the display block 31 updates the pixels 3112(1276) to 3112(1282) according to the pixel data D(1276) to D(1282).

After having transmitted the pixel data D(1276) to D(1282), the system block 32 transmits an end code to the display block 31. The end code represents the end of a display line, and is generated by maintaining a predetermined period TE. Alternatively, the end code may also be achieved by a fixed code. Having transmitted the end code, the display block 31 receives the dot start code 101 and the dot address code 0101 of the next display line, indicating that the 6^{th} vertical block needs to be updated. The 6^{th} vertical block comprises the pixels 3112(426) to 3112(510), and so the display block 31 starts updating from the 426^{th} pixel 3112(426), and updates the pixels 3112(426) to 3112(432) according to the pixel data D(426) to D(432). For illustration purposes, the line start code and the dot start code having the same coding method and the same code length are given as an example in the second embodiment. In another embodiment, the line start code and the dot start code may have different code lengths or different coding methods.

### Third Embodiment

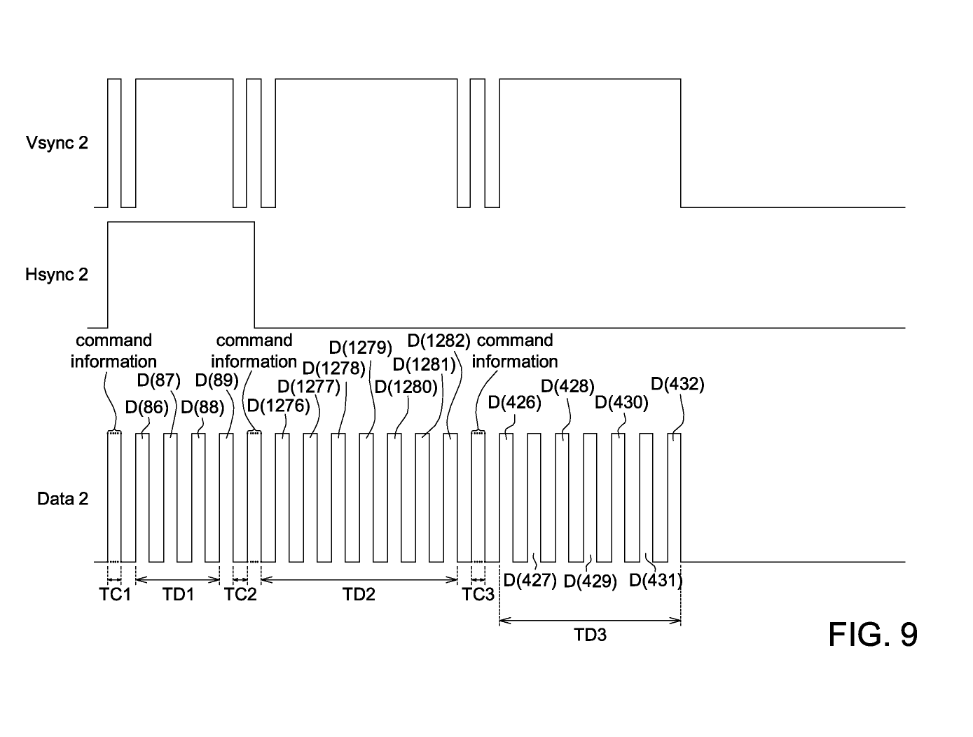

FIG. 9 shows a partial timing diagram of a vertical synchronization signal, a horizontal vertical synchronization signal and partial frame data according to a third embodiment. Referring to FIGS. 3, 5, 6 and 9, a main difference of the third embodiment from the second embodiment is that, the start information ST, the address information AD and the partial frame data DF in the third embodiment are all transmitted via the data bus 35. In the third embodiment, in addition to the pixel data D(86) to D(89), the pixel data D(1276) to D(1282) and the pixel data D(426) to D(432), the data signal Data2 further comprises command information. The command information comprises the start information ST and the address information AD. The data bus 35 transmits corresponding command information in transmission periods TC1 to TC3, respectively, and transmits corresponding pixel data in the data transmission periods TD1 to TD3, respectively. In the data transmission period TD1, the data transmission period TD2 and the data transmission period TD3, the vertical synchronization signal Vsync2 maintains at an enable level.

For example, the data bus 35 first transits the line start code 101, the line address code 0101, the dot start code 101 and the dot address code 0001 in the command transmission period TC1, and transmits the pixel data D(86) to D(89) in the data transmission period TD1. The data bus 35 then transmits the dot start code 101 and the dot address code 1111 in the command transmission period TC2, and transmits the pixel data D(1276) to D(1282) in the data transmission period TD2. Next, the data bus 35 transmits the start code 101, the dot address code 0101 and the end code (representing the start of the next display line) in the command transmission period TC3, and transmits the pixel data D(426) to D(432) in the data transmission period TD3. As the data bus 35 is capable of transmitting several bits each time, the transmission time for transmitting the start information ST and the address information AD can be reduced by transmitting the start information ST and the address information AD via the data bus 35.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic apparatus, comprising:
a display block, comprising:
a display panel, for displaying a frame;
a system block, comprising:
a comparison unit, for comparing first frame data with second frame data to generate partial frame data;
an information generation unit, for generating start information and address information according to the partial frame data; and
a transmission circuit, for transmitting the start information, the address information and the partial frame data to the display block;
wherein, the display block updates a part of the frame according to the start information, the address information and the partial frame data.

2. The electronic apparatus according to claim 1, wherein the display panel comprises a display line, the display line comprises a plurality of pixels in a horizontal arrangement, the start information comprises a line start code, the address information comprises a line address code, the partial frame data comprises a plurality of sets of pixel data respectively corresponding to the pixels, and the display block updates the pixels according to the line start code, the line address code and the pixel data.

3. The electronic apparatus according to claim 1, wherein the display panel comprises a display line, the display line comprises a plurality of pixels in a horizontal arrangement, the start information comprises a line start code and a dot start code, the address information comprises a line address code and a dot address code, the partial frame data comprises a plurality of sets of pixel data respectively corresponding to the pixels, and the display block updates a part of the pixels according to the line start code, the line address code, the dot start code, the dot address code and the pixel data.

4. The electronic apparatus according to claim 3, wherein the system block transmits an end code to the display block when the pixel data is completely transmitted.

5. The electronic apparatus according to claim 3, wherein the line start code and the dot start code have a same coding method.

6. The electronic apparatus according to claim 3, wherein the line start code and the dot start code have different coding methods.

7. The electronic apparatus according to claim 3, wherein the line start code and the dot start code have a same code length.

8. The electronic apparatus according to claim 3, wherein the line start code and the dot start code have different code lengths.

9. The electronic apparatus according to claim 1, further comprising:
a vertical synchronization signal line, for transmitting the start information and the address information; and
a data bus, for transmitting the partial frame data.

10. The electronic apparatus according to claim 1, further comprising:
a data bus, for transmitting the start information, the address information the partial frame data.

11. A frame updating method, comprising:
displaying a frame;
comparing first frame data with second frame data to generate partial frame data;
generating start information and address information according to the partial frame data;
transmitting the start information, the address information and the partial frame data by a system block to a display block; and
updating a part of the frame according to the start information, the address information and the partial frame data by the display block.

12. The frame updating method according to claim 11, wherein the display panel comprises a display line, the display line comprises a plurality of pixels in a horizontal arrangement, the start information comprises a line start code, the address information comprises a line address code, the partial frame data comprises a plurality of sets of pixel data respectively corresponding to the pixels, and the display block updates the pixels according to the line start code, the line address code and the pixel data.

13. The frame updating method according to claim 11, wherein the display panel comprises a display line, the display line comprises a plurality of pixels in a horizontal arrangement, the start information comprises a line start code and a dot start code, the address information comprises a line address code and a dot address code, the partial frame data comprises a plurality of sets of pixel data respectively corresponding to the pixels, and the display block updates a part of the pixels according to the line start code, the line address code, the dot start code, the dot address code and the pixel data.

14. The frame updating method according to claim 13, wherein the system block transmits an end code to the display block when the pixel data is completely transmitted.

15. The frame updating method according to claim 13, wherein the line start code and the dot start code have a same coding method.

16. The frame updating method according to claim 13, wherein the line start code and the dot start code have different coding methods.

17. The frame updating method according to claim 13, wherein the line start code and the dot start code have a same code length.

18. The frame updating method according to claim 13, wherein the line start code and the dot start code have different code lengths.

19. The frame updating method according to claim 11, wherein the start information and the address information are transmitted via a vertical synchronization signal line, and the partial frame data is transmitted via a data bus.

20. The frame updating method according to claim 11, wherein the start information, the address information and the partial frame data are transmitted via a data bus.
